(19) United States
(12) Patent Application Publication
(10) Pub. No.: US 2026/0212015 A1
(43) Pub. Date: Jul. 23, 2026

(54) SYSTEM AND METHOD FOR MALWARE DETECTION IN CYBER SECURITY SOLUTION

(71) Applicant: PROYAVA INNOVATIONS PVT. LTD., Mysuru, Karnataka (IN)

(72) Inventor: Pranesh *, Mysuru (IN)

(73) Assignee: PROYAVA INNOVATIONS PVT. LTD., Mysuru, Karnataka (IN)

(21) Appl. No.: 19/143,248

(22) PCT Filed: Feb. 20, 2024
(86) PCT No.: PCT/IB2024/051625

§ 371 Date: Jun. 25, 2025

(30) Foreign Application Priority Data
Feb. 22, 2023 (IN) 202341011891

(51) Int. Cl. G06F 21/56

(52) U.S. Cl. CPC G06F 21/566; G06F 2221/034

(57) ABSTRACT

Disclosed is a malware detection system that employs behavior-based malware detection to detect malware within a target computing device. The system comprises a data collection module for capturing processing activity within the target device, an activity database for storing the captured activity data in samples, a comparison module for comparing the activity data pertaining to a sample against behavior-based malware behaviors listed within a behavioral database, a sample ranking module for assigning multiple sample ranks to the sample upon match, and a batch ranking module for assigning multiple ranks to a sample batch wherein, a batch rank is a function of corresponding sample ranks. The target device is deemed to be malware infected in the event of the batch rank being beyond threshold limit, at which point, the system is configured to issue a malware-detection notification.

### TECHNICAL FIELD

The present disclosure relates to malware detection applications and more particularly to a novel, malware detection system & method that identifies malware within a computing device by employing behavior-based malware detection.

### BACKGROUND

Most malware detection software applications rely on databases of signature-based malware signatures, which are defined by specific features such as, its technology, size, code sequences, instruction sets, etc. These signatures are used to identify malware on a target computer and trigger a warning or removal process. However, this approach has a significant limitation: if a new type of malware is introduced that does not match any of the existing signatures, it may go undetected and continue to operate on the computer.

### SUMMARY

An embodiment of the present disclosure teaches a malware detection system for detecting malware activity within a target computing device based on the behavior thereof.

The malware detection system comprises a processor, which is further divided into a plurality of processing modules which will be disclosed in the following body of text. The system further comprises a behavioral database. While a data collection module is disposed within a target computing device, all other processing modules are disposed within a server device. The communication between the target and server devices is facilitated by a dedicated communication channel employing one or a combination of: file sharing, File Transfer Protocol (FTP), Telnet, Application Programming Interface (API), network file exchange, web-based exchange mechanisms and Secure Copy Protocol (SCP).

The behavioral database lists multiple malware behaviors therewithin wherein, each malware behavior is associated with set of behavioral activities that collectively represent the behavior of the corresponding malware software application. Further, each behavioral activity is in turn associated with a probability score, which represents weightage thereof within the corresponding behavioral set thereof.

The data collection module monitors and captures processing activity within the target device. The processing data is collected based on data collection criteria and periodicity. Notably, the parameters for the data collection criteria are configurable via a management module that includes a user interface. The activity data captured by the data collection module is then stored within an activity database in in samples, each of which being of a predetermined duration. Notably, before being stored within the activity database, the activity data samples are normalized meaning, the activity data is filtered off unwanted data, sorted, uniformized, and optimized.

A comparison module receives the samples from the activity database for further processing. The comparison module compares the activity captured by said sample against the behavioral activity set of each malware behavior listed within the behavioral database. For each match between a captured activity (of the sample) and a behavioral activity of a behavioral activity set, the corresponding probability score is attributed to sample. As a result, for each malware behavior, each sample accrues a total probability score, which will be referred to as a sample malware probability sum hereinafter.

A sample ranking module assigns the sample (attributed with multiple sample probability sums) with multiple sample ranks wherein, each sample rank, in one embodiment, represents a sample probability sum thereof. A sample assigned with multiple sample ranks will hereinafter be referred to as a ranked sample.

A batch ranking module, on the other hand, assigns multiple batch ranks to a sample batch, which comprises a predetermined number of ranked samples. A batch rank represents a batch malware probability sum, which in turn comprises sum of sample probability sums that correspond to one malware behavior.

The batch ranking module receives the sample batches in a rolling time manner, meaning there is a considerable number of ranked samples common between any two consecutive sample batches. For instance, if the size of a sample batch is set to be 10 and if the common number of ranked samples between two consecutive sample batches is set to 8, then consecutive first and second sample batches will contain 8 common ranked samples therebetween barring the first ranked sample of the first sample batch and the last ranked sample of the second sample batch. This method is more effective, consistent and is thereby more foolproof as a malware activity may span more than one sample batch at a time.

The malware detection system is configured such that, if a batch rank of a sample batch is beyond a predetermined threshold limit, then it is deemed that the target device is infected with the corresponding malware. At this point, a notification module issues a notification if it is determined that the target device is malware-infected. The notification is also relayed to the management module, which helps in further configuring the data collection module for better data collection criteria.

Other features and advantages will become apparent from the following description of the preferred embodiments, taken in conjunction with the accompanying drawings.

### BRIEF DESCRIPTION OF FIGURES

FIG. 1 is, according to an embodiment of the present disclosure, a block diagram of the malware detection system.

FIG. 2 is, according to an embodiment of the present disclosure, a flowchart depicting the malware detection method.

### DETAILED DESCRIPTION

Embodiments of the present disclosure are explained in detail below with reference to the various figures. In the following description, numerous specific details are set forth to provide an understanding of the embodiments and examples. However, those of ordinary skill in the art will recognize several equivalent variations of the various features provided in the description. Furthermore, the embodiments and examples may be used together in various combinations.

The present disclosure teaches a malware detection system & method for detecting malware activity within a target computing device based on behavior-based malware detection. The malware detection system & method are further based on a novel algorithmic technique that processes activity data captured from the target device in a rolling time manner.

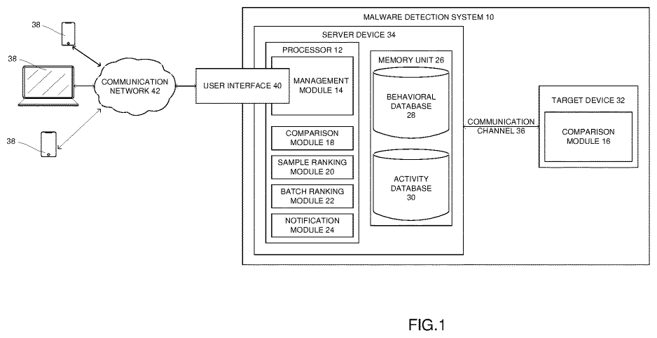

Referring to FIG. 1, the malware detection system 10 comprises a processor 12, which is further divided into a plurality of processing modules viz., a management module 14, a data collection module 16, a comparison module 18, a sample ranking module 20, a batch ranking module 22 and a notification module 24. The system 10 further comprises a memory unit 26 comprising a behavioral database 28 and an activity database 30. While the data collection module 16 is disposed within a target computing device 32, all the other modules and the memory unit 26 are disposed within a server device 34. In one embodiment, there could be multiple target devices 32 that disposed in operative communication with the server device 34. The communication between the target 32 and server devices 34 is facilitated by a dedicated communication channel 36 employing one or a combination of: file sharing, File Transfer Protocol (FTP), Telnet, Application Programming Interface (API), network file exchange, web-based exchange mechanisms, and Secure Copy Protocol (SCP). In one embodiment, all the modules and the memory unit 26 reside and operate locally within the target device 32 itself.

Referring to FIG. 1, the behavioral database 28 lists multiple malware behaviors therewithin wherein, each malware behavior is representative of a corresponding malware software application. More particularly, a malware behavior includes malware behavioral configuration, malware behavioral sequence, configuration, and activity list. Within the behavioral database 28, each malware behavior is associated with set of one or more behavioral activities that collectively represent the behavior of the corresponding malware application within a computing device. As can be appreciated from the following TABLE 1, the exemplary malwares M1 & M2 represent the behavioral activities associated therewith. Notably, the malware M2 represents a typical file locker ransomware application. In one embodiment, the sequence of the behavioral activities of a malware behavior is also instrumental in detecting malware within a computing device.

TABLE 1

| MALWARE M1 | MALWARE M2 |
|---|---|
| Deletion of file(s) | Non-system application execution |
| Updating system information | Accessing file(s) |
| Renaming of system application(s) | Updating file(s) with file attributes |
| Replacing system file(s) | Deletion of file(s) |

Referring to FIG. 1, further within the behavioral database 28, each of the one or more behavioral activities is in turn associated with a probability score, which represents weightage thereof within the corresponding behavioral set thereof. It also may represent of the probability of the corresponding malware application running within the target device 32. The following TABLE 2 exemplarily depicts the various probability scores of the behavioral activity set pertaining to the malware M2.

TABLE 2

| | ACTIVITY | PROBABILITY |
|---|---|---|
| MALWARE M2 ACTIVITY | CODE | SCORE (%) |
| Non-system application execution | M21 | 20 |
| User in admin privilege | M22 | 10 |
| Updating file attributes for size, type, | M23 | 60 |
| extension, etc. | | |
| Deletion of file | M24 | 10 |

Referring to FIG. 1, the data collection module 16 is purposed for monitoring and capturing processing activity within the target device 32. The processing data is collected based on data collection criteria and periodicity. Notably, the parameters for the data collection criteria are configurable via the management module 14. More particularly, the configuration is provided from a user terminal 38 as facilitated by a user interface 40 (over a communication network 42) or via machine learning and artificial intelligence. In one embodiment, the data collection module 16 is adapted to capture the activity data at a pre-set time such as, for example, at 10 AM every day. In another embodiment, the activity capture is triggered upon the detection of a predesignated activity or activities within the target device 32. For example, the activity capture may commence upon the detection of the execution of a non-system application. In yet another embodiment, the activity capture commences after a preset duration of the commencement of the operation of the target device 32. In any case, the activity data captured by the data collection module 16 is then stored within the activity database 30 in in time-stamped samples (or sample sizes), each of which being of a predetermined duration. Notably, before being stored within the activity database 30, the activity data samples are normalized meaning, the activity data is filtered off unwanted data, sorted, uniformized, and optimized. Notably, a sample would be a snapshot of the operating system (OS), which collects, maintains, and accesses information related to services provide by said OS. For example, a snapshot of time duration “T” would be the user login during T, files and/or folders accessed and updated during T, installed and running applications during T, network usage during T, etc. The sample includes newly created, deleted, and updated information.

Referring to FIG. 1, the comparison module 18, which works in conjunction with the memory unit 26, receives samples from the activity database 30 for further processing. In one embodiment, the samples are processed one sample at a time by the comparison module 18. Upon the reception of a sample, the comparison module 18 compares the activity captured by said sample against the behavioral activity set of each malware behavior listed within the behavioral database 28. For each match between a captured activity (of the sample) and a behavioral activity of a behavioral activity set, the corresponding probability score is attributed to sample.

For example, referring to TABLE 2, if the “deletion of a file (M24)” activity is detected within the sample once, then a probability score of 10% is attributed to said sample. If activity M21 is detected within the same sample (in addition to M24), then a sample malware probability sum of 30% (i.e., 10% probability score for M24 and 20% probability score for M21) is attributed to said sample. In another example, if activity M21 is detected twice within the sample, then a sample probability sum of 50% (i.e., 10% probability score for M24, 20% probability score for the first M21 and 20% probability score for the second M21) is attributed to said sample. All in all, a sample probability sum of 50% is attributed the sample for malware behavior for M2. The same comparison and attribution process is repeated for every behavioral activity set of every malware behavior until the sample is attributed with the number of sample probability sums that is equivalent to that of the malware behaviors. Notably, by regulating the probability scores, the sensitivity of the malware detection system may be increased or decreased accordingly.

Referring to FIG. 1, the sample ranking module 20, which is disposed in operative communication with the comparison module 18, assigns the sample (attributed with multiple sample probability sums) with multiple sample ranks wherein, each sample rank represents a sample probability sum of the sample. In one embodiment, the sample rank is a function of the corresponding probability score. In another embodiment, the sample rank comprises the sample probability sum itself. As can be inferred from the earlier body of text, the number of sample ranks of the sample is equivalent to that of the malware behaviors listed within the behavioral database 28. A sample assigned with multiple sample ranks will hereinafter be referred to as a ranked sample.

Referring to FIG. 1, the batch ranking module 22, which is disposed in operative communication with the sample ranking module 20, assigns multiple batch ranks to a sample batch. A sample batch comprises a predetermined number of ranked samples. A batch rank represents a batch malware probability sum, which in turn comprises sum of sample probability sums that correspond to one malware behavior.

For example, if a sample batch comprises three ranked samples and the captured activity of each ranked sample is earlier compared and processed (by the comparison module 18) against the behavioral activity sets of three malware behaviors, then the batch probability sum for a first malware behavior is the sum of: the sample probability sum of the first ranked sample for the first malware behavior, the sample probability sum of the second ranked sample for the first malware behavior and the sample probability sum of the third ranked sample for the first malware behavior as well.

In one embodiment, the batch rank is a function of the corresponding batch probability sum. In another embodiment, the batch rank comprises the batch probability sum itself. As can be inferred from the earlier body of text, the number of batch ranks of the sample batch is equivalent to that of the malware behaviors listed within the behavioral database 28.

Referring to FIG. 1, the batch ranking module 22 receives the sample batches in a rolling time manner, meaning there is a considerable number of ranked samples common between any two consecutive sample batches. For instance, if the size of a sample batch is set to be 10 and if the common number of ranked samples between two consecutive sample batches is set to 6, then consecutive first and second sample batches will contain 6 common ranked samples therebetween barring the first two ranked samples of the first sample batch and the last two ranked samples of the second sample batch. In another instance, if the common number of ranked samples between two consecutive sample batches is set to 8, then consecutive first and second sample batches will contain 8 common ranked samples therebetween barring the first ranked sample of the first sample batch and the last ranked sample of the second sample batch. This method is more effective, consistent and is thereby more foolproof as a malware activity may span more than one sample batch at a time. In one embodiment, instead of fixing the batch size of a sample batch, the time processing time of the batch ranking module is fixed. For instance, if the processing time of the batch ranking module 22 is fixed to be 60 seconds and the duration of each ranked sample is 10 seconds, then the size of a sample batch would be 6.

Referring to FIG. 1, the malware detection system 10 is configured such that, if a batch rank of a sample batch is beyond a predetermined threshold limit, then it is deemed that the target device 32 is infected with the corresponding malware. For example, in the embodiment where the batch rank comprises the batch probability sum itself, if the batch rank is determined to be beyond, say, 60%, then it is deemed that a corresponding malware application operates within the target device 32. Notably, by regulating the threshold limit, the sensitivity of the malware detection system 10 may be increased or decreased accordingly. Notably, the time taken for determining whether the target device 32 is malware-infected greater than the time taken for assigning sample ranks to samples, which in turn is greater than the time taken for capturing activity data from the target device 32.

Referring to FIG. 1, the notification module 24 issues a notification if it is determined that the target device 32 is malware-infected. The notification also includes the timestamp of the notification, the identity of the target device 32, the probability of the malwares associated with the sample batch, the behaviors detected from the sample batch and suggested action. The notification module 24 relays a copy of the notification to the management module 14, which helps in further configuring the data collection module 16 for better data collection criteria.

Referring to FIG. 1, the configuration communication from the management module 14 to the data collection module 16 is based on communication mechanism and communication specification. The communication mechanism is, as mentioned earlier, the mechanism by which information is exchanged between the target and server devices 32 and 34 which may comprise file sharing, FTP, Telnet, SCP, API, etc. The communication specification on the other hand is about the what information is communicated to the data collection module, which includes: time durations, criteria to report an event, application names, program characteristics, file and/or folder attributes, communication identifiers, and communication security mechanism. The data collection module 16 also collects Operating System (OS) related information such as, system information related to the user, applications and processes running within the target device 32, the file system of the target device 32, etc., for further improving the criteria for data collection by the data collection module 16. The notification could be electronic communication, an alarm sound, a message, a dashboard notification, a glowing notification light, etc., which could be interpreted by a human or another computer system. In one embodiment, each malware is assigned a different notification.

Referring to FIG. 1, when the malware detection system 10 is installed within the target device 32, the details of the target device 32 are received by the management module 14. Said details of the target device 32 include the owner(s) or user(s) thereof, system attributes like the OS thereof, applications and processes running therewithin, network thereof, the type of device (such as, laptop, PC, server, etc.), the name thereof, IP address, MAC address, etc. Notably, the installation of the malware detection system 10 can either be manual or remote.

Referring to FIG. 1, the management module 14 further creates the context for the target device 32, which needs to be monitored with additional information like, internal identity, version of the malware detection system 10 installed within the target device 32, license/subscription information, unique access key (to protect the communication channel), the communication mechanism employed, etc. Notably, the “handshake” and exchange of security keys between the target device 32 and the malware detection system 10 (i.e., the server device 34) is done using two-way handshaking and license/subscription verification. The communication mechanism is secured using secure transport mechanisms like https, TLS, etc.

Referring to FIG. 1, particularly initially, the management module 14 communicates with the target device 32 via pre-configured communication mechanism. The pre-configured communication is all about what information needs to be captured within the target device 32 including the applications, devices, file system, network, time duration, repeatability, criteria, and conditions by which the target device 32 shares monitoring information to the server device 34. Notably, configuration communication is performed at the beginning as a first step and during updated configuration communication on a need basis. In the event of a restart of the target device 32, said target device 32 uses the latest configuration information from the management module 14 for data collection criteria.

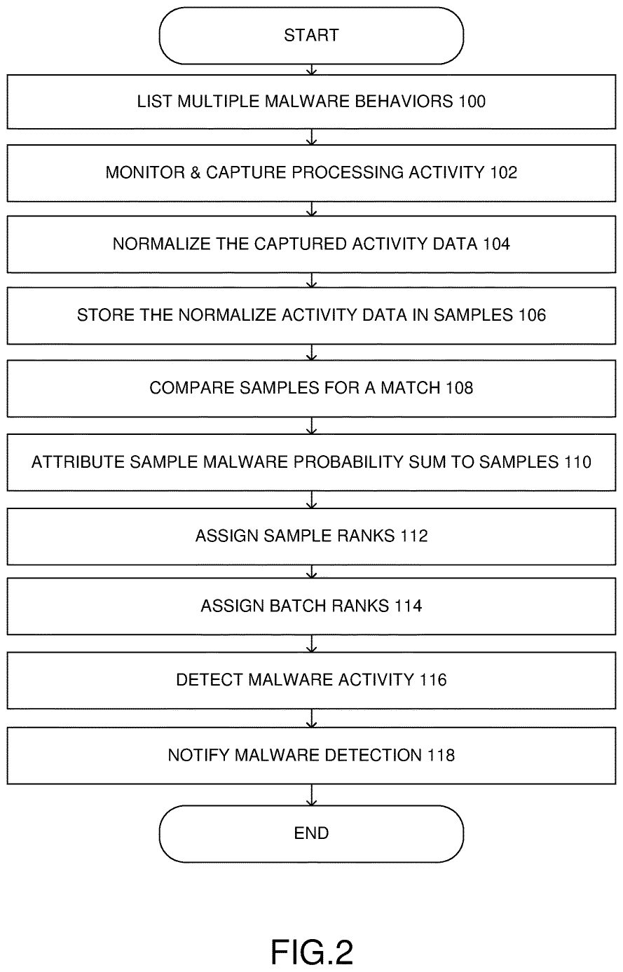

Referring to FIG. 2, the malware detection method initiates with listing (step 100) multiple malware behaviors within a behavioral database wherein, each malware behavior is representative of a corresponding malware application. More particularly, a malware behavior includes malware behavioral configuration, malware behavioral sequence, configuration, and signature. Within the behavioral database, each malware behavior is associated with set of one or more behavioral activities that collectively represent the corresponding malware application within a target computing device. As can be appreciated from TABLE 1, the exemplary malwares M1 & M2 represent the behavioral activities associated therewith.

Further within the behavioral database, each of the one or more behavioral activities is in turn associated with a probability score, which represents weightage thereof within the corresponding behavioral set thereof. It also may represent of the probability of the corresponding malware application running within the target device. TABLE 2 exemplarily depicts the various probability scores of the behavioral activity set pertaining to the malware M2.

Referring to FIG. 2, the method further includes monitoring and capturing (step 102) processing activity within a target computing device. The processing data is collected based on data collection criteria and periodicity. Notably, the parameters for the data collection criteria are configurable. In one embodiment, the data collection module 16 is adapted to capture the activity data at a pre-set time. In another embodiment, the activity capture is triggered upon the detection of a predesignated activity or activities within the target device. In any case, once the activity data is captured, then the method further includes storing (step 106) the captured activity data within an activity database in time-stamped samples (or sample sizes) wherein, each sample is of a predetermined duration. Notably, before being stored within the activity database, the method further includes normalizing (step 104) activity data samples, which would mean, the activity data being filtered off unwanted data, sorted, uniformized, and optimized.

Referring to FIG. 2, the method further includes comparing (step 108) captured activity data against a behavioral activity set of each malware behavior listed within the behavioral database. More particularly, the method includes the activity captured by a sample against the behavioral activity set of each malware behavior listed within the behavioral database. For each match between a captured activity (of the sample) and a behavioral activity of a behavioral activity set, the method includes attributing (step 110) a corresponding probability score to the sample.

Referring to FIG. 2, for example, referring to TABLE 2, if the “deletion of a file (M24)” activity is detected within the sample once, then a probability score of 10% is attributed to said sample. If activity M21 is detected within the same sample (in addition to M24), then a sample malware probability sum of 30% (i.e., 10% probability score for M24 and 20% probability score for M21) is attributed (step 110) to said sample. In another example, if activity M21 is detected twice within the sample, then a sample probability sum of 50% (i.e., 10% probability score for M24, 20% probability score for the first M21 and 20% probability score for the second M21) is attributed (step 110) to said sample. All in all, a sample probability sum of 50% is attributed (step 110) the sample for malware behavior for M2. The method further includes repeating the same comparison (step 108) and attribution (step 110) process for the behavioral activity set of every malware behavior until the sample is attributed (step 110) with the number of sample probability sums that is equivalent to that of the malware behaviors listed within the behavioral database. Notably, by regulating the probability scores, the sensitivity of the malware detection system may be increased or decreased accordingly.

Referring to FIG. 2, the method further includes assigning multiple sample ranks (step 112) to the sample (attributed with multiple sample probability sums) wherein, each sample rank represents a sample probability sum of the sample. In one embodiment, the sample rank is a function of the corresponding probability score. In another embodiment, the sample rank comprises the sample probability sum itself. As can be inferred from the earlier body of text, the number of sample ranks of the sample is equivalent to that of the malware behaviors listed within the behavioral database. A sample assigned with multiple sample ranks will hereinafter be referred to as a ranked sample.

Referring to FIG. 2, the method further includes assigning multiple batch ranks (step 114) to a sample batch comprising a predetermined number of ranked samples. A batch rank represents a batch malware probability sum, which in turn comprises sum of sample probability sums that correspond to one malware behavior. In one embodiment, the batch rank comprises a function of the corresponding batch probability sum. In another embodiment, the batch rank comprises the batch probability sum itself. As can be inferred from the earlier body of text, the number of batch ranks of the sample batch is equivalent to that of the malware behaviors listed within the behavioral database.

For batch ranking, the sample batches are processed in a rolling time manner, meaning there is a considerable number of ranked samples common between any two consecutive sample batches. For instance, if the size of a sample batch is set to be 10 and if the common number of ranked samples between two consecutive sample batches is set to 6, then consecutive first and second sample batches will contain 6 common ranked samples therebetween barring the first two ranked samples of the first sample batch and the last two ranked samples of the second sample batch. This method is more effective, consistent and is thereby more foolproof as a malware activity may span more than one sample batch at a time. In one embodiment, instead of fixing the batch size of a sample batch, the time processing time of the batch ranking module is fixed. For instance, if the processing time of the batch ranking module is fixed to be 60 seconds and the duration of each ranked sample is 10 seconds, then the size of a sample batch would be 6.

Referring to FIG. 2, the malware detection method is configured such that, if a batch rank of a sample batch is beyond a predetermined threshold limit, then it is deemed (step 116) that the target device is infected with the corresponding malware. For example, in the embodiment where the batch rank comprises the batch probability sum itself, if the batch rank is determined to be beyond, say, 60%, then it is deemed that a corresponding malware application operates within the target device

Referring to FIG. 2, the method further includes issuing a notification (step 118) if it is determined that the target device is malware-infected. The notification also includes the timestamp of the notification, the identity of the target device, the probability of the malwares associated with the sample batch, the behaviors detected from the sample batch and suggested action. The method further includes configuring the data collection module for better data collection criteria based on the information contained within the notification.

The aforementioned embodiments are able to be implemented, for example, using a machine-readable medium or article which is able to store an instruction or a set of instructions that, if executed by a machine, cause the machine to perform a method and/or operations described herein. Such machine can include, for example, any suitable processing platform, computing platform, computing device, processing device, electronic device, electronic system, computing system, processing system, computer, processor, or the like, and is able to be implemented using any suitable combination of hardware and/or software. The machine-readable medium or article is able to include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions can include any suitable type of code, for example, source code, compiled code, interpreted code, executable code, static code, dynamic code, or the like, and is able to be implemented using any suitable high-level, low-level, object-oriented, functional-programming, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, can be combined with, or is able to be utilized in combination with, one or more other functions, operations, components and/or features described herein with reference to one or more other embodiments, or vice versa.

Embodiments and examples are described above, and those skilled in the art will be able to make various modifications to the described embodiments and examples without departing from the scope of the embodiments and examples.

Although the processes illustrated and described herein include series of steps, it will be appreciated that the different embodiments of the present disclosure are not limited by the illustrated ordering of steps. Some steps may occur in different orders, some concurrently with other steps apart from that shown and described herein. In addition, not all illustrated steps may be required to implement a methodology in accordance with the present disclosure. Moreover, it will be appreciated that the processes may be implemented in association with the apparatus and systems illustrated and described herein as well as in association with other systems not illustrated.

What is claimed is:

1. A malware detection system comprising:
(a) a configurable data collection module disposed within a target computing device for monitoring and capturing processing activity therewithin;
(b) a memory unit comprising:
(i) an activity database for storing the captured activity data in time-stamped samples; and
(ii) a behavioral database comprising multiple malware behaviors, each of which associated with a set of one or more behavioral activities that collectively indicate of the behavior of a corresponding malware software application, each of the one or more behavioral activities associated with a probability score;
(c) a comparison module for comparing each activity captured within a sample against the behavioral activity set of each of the plurality of malware behaviors;
(d) a sample ranking module for assigning multiple sample ranks to the sample, a sample rank representative or function of a sample malware probability sum of the sample, the sample probability sum being the sum of the probability scores accrued by the sample upon match of the captured activity or activities thereof against the behavioral activity set of a malware behavior, a sample assigned with multiple sample ranks referred to as a ranked sample, the number of sample ranks assigned to a sample being equivalent to the number of malware behaviors listed within the behavioral database, each sample rank corresponding to a malware behavior;
(e) a batch ranking module for assigning multiple batch ranks to a sample batch of predetermined number of ranked samples, a batch rank representative or function of a batch malware probability sum of the sample batch, the batch probability sum being sum of sample probability sums of the corresponding ranked samples, said sum of the sample probability sums corresponding to one malware behavior, the target device deemed to be malware-infected in the event of a batch rank being beyond a predetermined threshold limit, the number of batch ranks assigned to a sample batch being equivalent to the number of malware behaviors listed within the behavioral database, each batch rank corresponding to a malware behavior; and
(f) a notification module for issuing a notification in the event of malware detection.

2. The system of claim 1 wherein, the activity is captured within the target device at a pre-set time.

3. The system of claim 1 wherein, the activity capture commences upon the detection of a predetermined activity or activities within the target device.

4. The system of claim 1 wherein, a time-stamped sample is of a predetermined duration.

5. The system of claim 1 wherein, the memory unit, comparison module, ranking module and the notification module reside outside of the target device and within a server device.

6. The system of claim 6 wherein, the communication between server device and the data collection module is facilitated by a communication channel employing one or a combination of: file sharing, File Transfer Protocol, Telnet, Application Programming Interface, network file exchange, web-based exchange mechanisms and Secure Copy Protocol.

7. The system of claim 1 wherein, the data collection module further collects information related to the one or more users of the target device, processes and applications running within the target device, the file system of the target device and one or more other devices connected to the target device.

8. The system of claim 1 wherein, the notification further includes: the time-stamp thereof, the probability of the malware or malwares associated with the sample batch, the identity of the target device, the behavior detected from the sample batch and suggested action.

9. The system of claim 8 wherein, the data collection module is configured based on the notification information.

10. The system of claim 1 wherein, any two consecutive first and second sample batches processed by the batch ranking module comprise a common number of samples barring the at least one consecutive first sample of the first batch and the at least one consecutive last sample of the second batch.

11. The entirety of the system of claim 1 being disposed within the target device.

12. A malware detection method comprising:
(a) listing multiple malware behaviors within a behavioral database, each malware behavior associated with a set of behavioral activities that collectively indicate of the behavior of a corresponding malware application, each behavioral activity pre-associated with a probability score;
(b) monitoring and capturing processing activity within a target computing device, the parameters for capturing the activity data being configurable;
(c) storing the captured activity data in time-stamped samples within an activity database;
(d) comparing each activity captured within a sample against a behavioral activity set of each malware behavior;
(e) assigning multiple sample ranks to a sample, a sample rank representative or function of a sample malware probability sum of the sample, the sample probability sum being the sum of the probability scores accrued by the sample upon match of the captured activity or activities thereof against the behavioral activity set of a malware behavior, a sample assigned with multiple sample ranks referred to as a ranked sample, the number of sample ranks assigned to a sample being equivalent to the number of malware behaviors listed within the behavioral database, each sample rank corresponding to a malware behavior;
(f) assigning multiple batch ranks to a sample batch of predetermined number of ranked samples, a batch rank representative or function of a batch malware probability sum of the sample batch, the batch probability sum being sum of sample probability sums of the corresponding ranked samples, said sum of the sample probability sums corresponding to one malware behavior, the target device deemed to be malware-infected in the event of a batch rank being beyond a predetermined threshold limit, the number of batch ranks assigned to a sample batch being equivalent to the number of malware behaviors listed within the behavioral database, each second rank corresponding to a malware behavior; and
(g) issuing a notification in the event of malware detection.

13. The method of claim 12 wherein, the activity is captured within the target device at a pre-set time or upon the detection of a predetermined activity or activities within the target device, or a combination thereof.

14. The method of claim 12 wherein, the storage of the captured activity data, comparison of the activity data, the assigning of the rank and notifying the outcome are performed outside of the target device and within a server device.

15. The method of claim 14 wherein, the communication between server device and the target device is facilitated by a communication channel using one of: file sharing, File Transfer Protocol, Telnet, Application Programming Interface, and Secure Copy Protocol.

16. The method of claim 12 further includes collecting information related to the one or more users of the target device, information pertaining to the processes and applications running within the target device, the file system information of the target device and any information of one or more devices connected to the target device.

17. The method of claim 12 wherein, the notification further includes the probability of the malwares associated with the sample batch, the identity of the target device, the behavior detected from the sample batch and suggested action.

18. The method of claim 17 wherein, the parameters for capturing the activity data are configurable based on the notification information.

19. The method of claim 12 wherein, any two consecutive first and second sample batches processed by the batch ranking module comprise a common number of samples barring the at least one consecutive first sample of the first batch and the at least one consecutive last sample of the second batch.

20. The entirety of the method of claim 12 being implemented within the target device.
